(19) United States
(12) Patent Application Publication
(10) Pub. No.: US 2017/0326702 A1
(43) Pub. Date: Nov. 16, 2017

(54) ROTARY TABLE DEVICE FOR MACHINE TOOL

(71) Applicant: TSUDAKOMA KOGYO KABUSHIKI KAISHA, Kanazawa-shi (JP)

(72) Inventors: Haruo Osaki, Kanazawa-shi (JP); Masato Shibahara, Kanazawa-shi (JP)

(21) Appl. No.: 15/592,245

(22) Filed: May 11, 2017

(30) Foreign Application Priority Data
May 12, 2016 (JP) 2016-096117
Feb. 27, 2017 (JP) 2017-034632

(51) Int. Cl. B23Q 16/10; B23Q 1/38

(52) U.S. Cl. CPC B23Q 16/10; B23Q 1/38

(57) ABSTRACT

A rotary table device that includes an air seal mechanism that prevents entry of foreign material into a frame by supplying compressed air to an air channel having a gap which is formed in a frame and which is defined by an outer peripheral surface of a rotating shaft and an inner peripheral surface of an accommodation hole in the frame at a side closer to a table than a bearing is, and by ejecting the compressed air from an inside of the frame. The air channel includes a storing portion that is disposed upstream from an ejection portion, the ejection portion being a most downstream side portion of the air channel, and a channel width of the storing portion is larger than a channel width of a portion of the air channel that is disposed downstream from the storing portion.

### BACKGROUND OF THE INVENTION

### 1. Field of the Invention

The present invention relates to a rotary table device that is for a machine tool and that includes a rotating shaft, a frame, a driving device, and a clamping device. A disc-shaped table for mounting a workpiece thereon is secured to one end of the rotating shaft. The frame has an accommodation hole for accommodating the rotating shaft, and rotatably supports the rotating shaft by a bearing in the accommodation hole. The driving device rotationally drives the rotating shaft. The clamping device is providing for holding the rotating shaft at an indexed angular position during indexing processing. In the rotary table device for a machine tool, the rotating shaft is rotationally driven at a peripheral speed of 10 m/s or greater by the driving device.

### 2. Description of the Related Art

In general, a rotary table device for a machine tool includes a rotating shaft to whose one end a disc-shaped table for mounting a workpiece thereon is secured and a frame that has an accommodation hole for accommodating the rotating shaft and that rotatably supports the rotating shaft via a bearing in the accommodation hole. In the rotary table device for a machine tool, the rotating shaft is rotationally driven by a driving device whose driving source is a driving motor. In addition, in a machine tool, such a rotary table device is used for contouring processing in which a workpiece is processed while the table is continuously rotated, and positioning processing in which the rotating shaft is secured at an indexed angular position to process the workpiece. Since the rotary table device is used for performing such positioning processing, the rotary table device also includes a clamping device for holding the rotating shaft at an angular position indexed by the driving device (that is, for fixing the angular position).

In general, in order to prevent entry of, for example, chips that are produced during processing or a coolant liquid used when processing a workpiece, such a rotary table device includes a sealing member or a sealing mechanism (hereunder generically referred to as a “sealing device”) that is disposed at a table-side end portion of the accommodation hole in the frame so as to be interposed between the rotating shaft and the frame. The rotary table device disclosed in Japanese Unexamined Patent Application Publication No. 2009-184021 (Patent Literature 1) also includes such a sealing device. Incidentally, the sealing device disclosed in Patent Literature 1 is a contact-type oil seal. In addition to the oil seal disclosed in Patent Literature 1, for example, a V ring, which is a contact-type sealing member, and a labyrinth seal, which is a non-contact-type sealing mechanism, exist as sealing devices that are used in the rotary table device.

In such a rotary table device, when the aforementioned contact-type sealing member, such as an oil seal or a V ring, or the aforementioned non-contact-type labyrinth seal, is used as a sealing device, the following problems may occur in the rotary table device.

First, when such a contact-type sealing member is used, the sealing member is secured to one of the frame and the rotating shaft, and is provided in sliding contact with the other of the frame and the rotating shaft. Therefore, as the rotating shaft is rotationally driven, the sealing member is brought into a state in which it slides with the rotating shaft or the frame, as a result of which wear of the sealing member cannot be avoided. As the wear progresses, the sealing performance by the sealing member in the rotary table device is reduced. Moreover, when the rotary table device is used under a condition of use in which the rotating shaft is rotationally driven at a high peripheral speed of 10 m/s or greater that is presupposed in the present invention, the sealing performance is reduced at an early stage due to the wear of the sealing member.

When, in the rotary table device, as mentioned above, the sealing performance is reduced, the aforementioned coolant liquid, chips, and the like tend to enter the frame. Therefore, it becomes necessary to replace the sealing member due to the wear. In the rotary table device that is used under such a condition of use described above, sealing members need to be replaced frequently.

In particular, due to, for example, design-related (or device-structure-related) reasons, the sealing member, such as a V ring, may be secured to the rotating shaft. In this case, when the rotating shaft is rotationally driven at a high speed as mentioned above, a contact portion of the sealing member with the frame is raised, as a result of which a gap is formed between the sealing member and the frame. As a result, for example, a coolant liquid or chips tend to enter the gap, thereby causing the sealing performance by the sealing member to be considerably reduced.

Since labyrinth seals are non-contact-type mechanisms whose relatively rotating portion is a non-contact portion, unlike the aforementioned contact-type sealing members, a reduction in sealing performance of labyrinth seals caused by wear does not occur. However, since labyrinth seals have non-contact structures, the sealing performance of such labyrinth seals is inferior to the sealing performance of contact-type sealing members. In some cases, a coolant liquid may penetrate a gap in the sealing member due to capillary action, and enter the frame. Therefore, a completely sealed state cannot be realized.

### SUMMARY OF THE INVENTION

In view of the problems of such an existing device, the present invention provides a sealing device that is capable of realizing a completely sealed state while having a structure in which a reduction in its sealing performance caused by, for example, wear does not occur in a rotary table device that has the aforementioned structure and that is used under a condition of use in which a rotating shaft is rotationally driven at a high speed as described above.

The present invention presupposes a rotary table device that is for a machine tool and that includes a rotating shaft to whose one end a disc-shaped table for mounting a workpiece thereon is secured; a frame that has an accommodation hole for accommodating the rotating shaft, and that rotatably supports the rotating shaft by a bearing in the accommodation hole; a driving device that rotationally drives the rotating shaft; and a clamping device that holds the rotating shaft at an indexed angular position during indexing processing, wherein the rotating shaft is rotationally driven at a peripheral speed of 10 m/s or greater by the driving device.

According to the present invention, to the aforementioned end, the presupposed rotary table device has the following structure.

The rotary table device includes an air seal mechanism which has a supply channel formed in the frame so as to communicate with a gap which is formed in the frame, which is defined by an inner peripheral surface of the accommodation hole in the frame and an outer peripheral surface of the rotating shaft, and which is positioned closer to the table than the bearing is. The air seal mechanism prevents entry of foreign material into the frame by supplying compressed air to an air channel and ejecting the compressed air from an inside of the frame, with the gap functioning as the air channel when the compressed air is supplied via the supply channel. The air channel includes a storing portion that is disposed upstream from an ejection portion, the ejection portion being a most downstream side portion of the air channel, and a channel width of the storing portion is larger than a channel width of a portion of the air channel that is disposed downstream from the storing portion.

The term “channel width” above refers to an interval between portions defining the air channel in a direction orthogonal to a direction of flow of compressed air supplied to the air channel towards the ejection portion, the interval between the portions being an interval between a portion of the frame and a portion of the frame or an interval between a portion of the frame and a portion of the rotating shaft. However, the expression “direction of flow of compressed air supplied to the air channel towards the ejection portion” refers to a direction other than a direction of flow towards a circumferential direction of the air channel among directions of flow of compressed air generated in the air channel when the compressed air being is supplied into the air channel. This is described in detail below. That is, the air channel exists along a circumference around the rotating shaft. As the compressed air is supplied to the air channel, the compressed air flows towards the ejection portion from a location (most upstream side) on substantially the same circumference in the air channel at the supply channel side, and is ejected from the ejection portion. In the air channel, in addition to the flow in this direction, a flow of compressed air in the circumferential direction of the air channel is also generated. However, the expression “direction of flow of compressed air supplied to the air channel towards the ejection portion” refers to, as in the expression “towards the ejection portion”, only the direction of flow towards the ejection portion from the upstream side and does not include the direction of flow in the circumferential direction.

In the present invention, the rotary table device has a structure in which, as a result of causing the supply channel in the frame to communicate with the gap that exists in the frame and supplying compressed air to the gap via the supply channel from an external air supplying device, the gap functions as an air channel of compressed air. In the rotary table device, since the air channel communicates with a table-side external portion at the ejection portion, which is a most downstream side portion, the compressed air is supplied to the air channel to eject the compressed air towards the table-side external portion from the ejection portion of the air channel. By this, according to the rotary table device of the present invention, when, during at least the processing of a workpiece, the compressed air is brought into a state in which it is supplied to the air channel and is ejected from the ejection portion, foreign materials such as chips that are produced during the processing and a coolant liquid that is used in the processing are prevented from entering the frame due to the action of compressed air that is ejected from the ejection portion.

The aforementioned foreign materials enter from a table-side opening of the gap in the frame. The sealing device according to the present invention prevents the entry of the aforementioned foreign materials by causing a sealing element having a sealing effect that prevents the entry of the aforementioned foreign materials to exist near the opening of the gap. Moreover, in the rotary table device according to the present invention, the sealing element is compressed air, and differs from a contact-type sealing member that realizes a sealed state by contact with another member. Therefore, the sealing device of the rotary table device is a non-contact-type sealing device. Consequently, a reduction in the sealing performance caused by wear as in the aforementioned contact-type sealing members does not occur. Moreover, compressed air, which serves as the sealing element, exists over the entire vicinity of the opening of the gap, and, unlike in the case of a labyrinth seal that is the same non-contact-type sealing device, a space (opening) that a coolant liquid can enter does not exist within the range of existence of the compressed air. Therefore, the sealing device is capable of realizing a completely sealed state.

In realizing a sealed state by the compressed air as described above, it is desirable to realize a state in which compressed air of a desired pressure is ejected from the entire ejection portion of the air channel that has the gap having a ring shape formed in the frame. However, in a structure in which the compressed air that is supplied to the air channel via the supply channel is directly ejected from the ejection portion, the amount of ejection of the compressed air that is ejected from each portion of the ejection portion (in the circumferential direction) is larger near a communication location where the supply channel communicates with the air channel, and becomes smaller with increasing distance from the communication location. Therefore, in this structure, a state in which compressed air of a desired pressure is not ejected may occur at the ejection portion that is far away from the communication location.

In contrast, the rotary table device of the present invention includes, as a structure for the sealing device, a ring-shaped storing portion, which is a portion of the air channel that is formed closer to the bearing than the ejection portion is, is provided; and the space of the storing portion is larger than the space of a downstream-side portion of the air channel (which includes the storing portion) that is located downstream from the storing portion. According to this structure, the compressed air supplied to the air channel via the supply channel is temporarily stored in the storing portion, and is subsequently ejected from the ejection portion via the downstream-side portion of the air channel. The result of temporarily storing the compressed air in the storing portion as mentioned above is that, in the storing portion, the pressure of the compressed air is brought into a state in which it is substantially uniform over the entire ring-shaped air channel. Therefore, according to such a sealing device, since compressed air having substantially uniform pressure over the entire ejection portion is ejected from the ejection portion, when the pressure of the compressed air that is supplied via the supply channel is set to a suitable pressure, compressed air having a desired pressure over the entire ejection portion is brought into a state in which it is ejected, and a completely sealed state is realized.

### BRIEF DESCRIPTION OF THE DRAWINGS

FIG. 1 is a front view of a rotary table device according to an embodiment of the present invention.

FIG. 2 is an enlarged front view of a main portion of the rotary table device according to the embodiment of the present invention.

FIG. 3 is a front view of a rotary table device according to another embodiment of the present invention.

### DESCRIPTION OF THE PREFERRED EMBODIMENTS

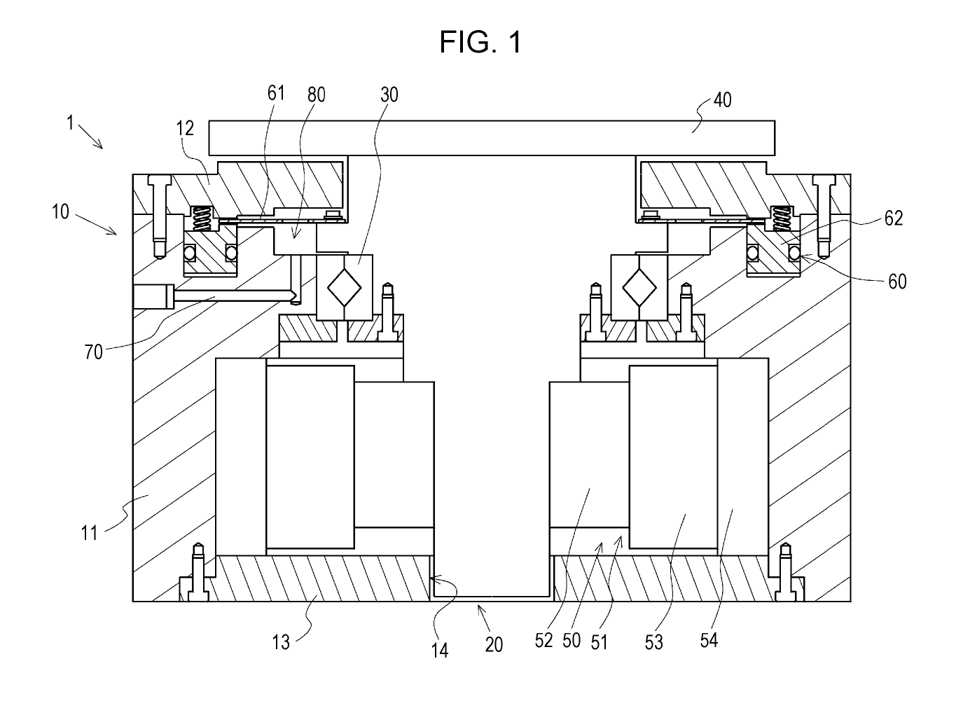

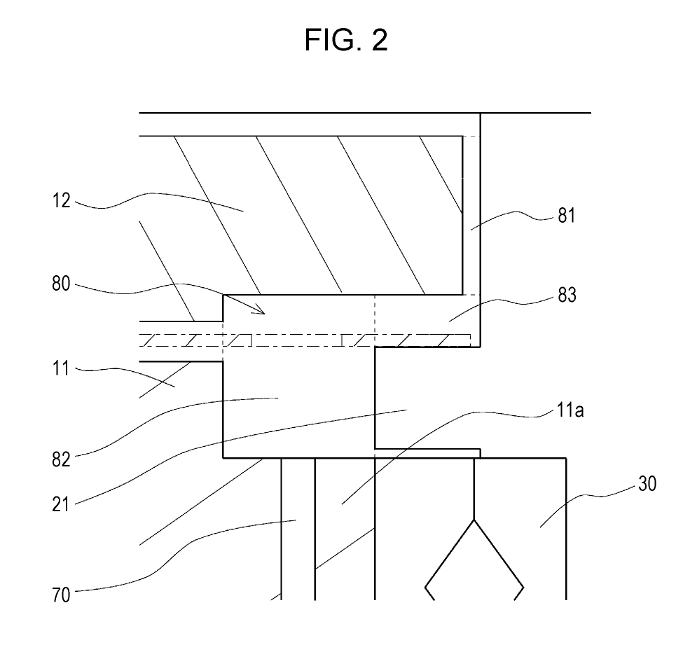

An embodiment according to the present invention is hereunder described with reference to FIGS. 1 and 2.

As shown in FIGS. 1 and 2, a rotary table device 1 includes a frame 10 that has an accommodation hole 14 and a rotating shaft 20 that is rotatably supported by the frame 10 in the accommodation hole 14 in the frame 10 via a bearing 30. The rotary table device 1 also includes a driving device 50 for rotationally driving the rotating shaft 20 and a clamping device 60 that holds the rotating shaft 20 during indexing processing. Each structural member of the rotary table device 1 is described in detail below.

The frame 10 includes a body 11, a cover 12, and a base 13, each having a through hole whose inside diameter allows the rotating shaft 20 to be inserted therein. The body 11 is a portion that occupies a large portion of the frame 10 in a direction of insertion of the rotating shaft 20, and is a principal portion of the frame 10. The body 11 has, as mentioned above, the through hole. The through hole opens at both end surfaces of the body 11, that is, is formed so as to extend through the body 11 from a one-end-side end surface to the other-end-side end surface of the body 11. Further, in a penetration direction of the through hole, the body 11 is formed such that the inside diameter of the through hole increases in a range from a substantially central portion to the other-end-side end surface. In other words, the through hole in the body 11 has a large-diameter portion whose inside diameter is larger than that of a portion of the body 11 at the one-end side in the range.

The cover 12 is a plate-like member. The cover 12 is mounted on the body 11 with a penetration direction of the through hole in the cover 12 coinciding with the penetration direction of the through hole in the body 11, the center of the through hole in the cover 12 coinciding with the center of the through hole in the body 11 in plan view, and one end surface of the cover 12 facing the one-end-side end surface of the body 11.

The base 13 is a ring-shaped member having an outside diameter that allows the base 13 to be inserted and fitted into the large-diameter portion of the through hole in the body 11. The base 13 is mounted on the body 11 with an outer peripheral surface of the base 13 being inserted and fitted into the large-diameter portion of the through hole in the body 11 and a position of one end surface of the base 13 being in correspondence with a position of the other-end-side end surface of the body 11 in the penetration direction of the through hole.

As described above, the frame 10 is formed by mounting the cover 12 and the base 13 on the body 11. In the frame 10 having such a structure, the through hole in the body 11, the through hole in the cover 12, and the through hole in the base 13 are continuously formed in the penetration direction. These through holes form the accommodation hole 14 in the frame 10.

In the rotary table device 1, the rotating shaft 20 is a member on which a disc-shaped table 40 for mounting a workpiece thereon is mounted (or by which the disc-shaped table 40 is supported). The rotating shaft 20 is disposed in the accommodation hole 14 in the frame 10 and, by the bearing 30 inserted between the body 11 and the rotating shaft 20, is rotatably supported by the frame 10. In a state in which the rotating shaft 20 is disposed in the accommodation hole 14 in this way, the rotating shaft 20 is disposed such that, in an axial direction of the rotating shaft 20, a portion of a one-end-side portion of the rotating shaft 20 protrudes slightly to the outside of the frame 10 from the other end surface of the cover 12 of the frame 10 (that is, the end surface opposite to the body 11).

Moreover, the table 40 is mounted on an end surface of the one-end-side portion of the rotating shaft 20 with a plate thickness direction of the table 40 coinciding with the axial direction. However, in the mounted state, the center of the table 40 is in a state in which it coincides with the axis of the rotating shaft 20 in plan view. In the mounted state, the rotary table device 1 has a narrow space between a frame-10-side end surface of the table 40 and the one-end-side end surface of the frame 10.

In the embodiment, the driving device 50 principally includes a direct driving motor (DD motor 51) that rotationally drives the rotating shaft 20 without using a drive transmission mechanism, such as gears. Incidentally, the DD motor 51 is a so-called inner-rotor-type DD motor 51 in which a motor rotor 52 is secured to the rotating shaft 20 and a motor stator 53 is secured to the frame 10 so as to surround the motor rotor 52. The driving device 50 also includes a stator sleeve 54 interposed between the motor stator 53 and the frame 10. In the large-diameter portion in the through hole in the body 11 of the frame 10, the driving device 50 is concentrically disposed with respect to an axis of the rotating shaft 20. The driving device 50 is connected to a controlling device of a machine tool (not shown) to control driving of the driving device 50 by the controlling device.

The driving device 50 is capable of rotationally driving the rotating shaft 20 at a rotational speed that causes a peripheral speed of the rotating shaft 20 to be 10 m/s or greater. However, the term “peripheral speed” here refers to the peripheral speed of the one-end-side portion of the rotating shaft 20 (that is, a portion of the rotating shaft 20 including a portion closest to the table 40 of an outer peripheral surface of the rotating shaft 20 facing an inner peripheral surface of the accommodation hole 14). That is, what is to be brought into a sealed state in the object of the present invention of preventing entry of foreign materials such as chips and a coolant liquid into the frame 10 is an opening between the cover 12 and the rotating shaft 20, which is a portion of the frame 10 that is closest to the table 40. Therefore, in the present invention, the peripheral speed, which represents the rotational speed of the rotating shaft 20, (that is, the rotational speed of the outer peripheral surface thereof) refers to the peripheral speed of the one-end-side portion of the rotating shaft 20 that forms this opening.

In the driving device 50, the stator sleeve 54 is ring-shaped, is inserted and fitted with respect to an inner peripheral surface of the large-diameter portion, and is secured to the frame 10 by using, for example, a screw member (not shown). By inserting and fitting the motor stator 53 with respect to (that is, press-fitting the motor stator 53 to) an inner peripheral surface of the stator sleeve 54, the motor stator 53 is provided in a state in which it is unrotatable relative to the stator sleeve 54. Therefore, the motor stator 53 is provided in a state in which it is unrotatable relative to the frame 10. Further, by inserting and fitting the rotating shaft 20 with respect to (that is, press-fitting the rotating shaft 20 to) an inner peripheral surface of the motor rotor 52, the motor rotor 52 is provided in a state in which it is unrotatable relative to the rotating shaft 20.

In the embodiment, the clamping device 60 is a so-called disc-type clamping device that holds the rotating shaft 20 by press-contacting a piston 62 with respect to a clamp disc 61 mounted on the rotating shaft 20. The clamping device 60 is also a normally unclamping type in which the piston 62 is normally urged by an urging force of a spring member in a direction away from the clamp disc 61 (that is, towards a side opposite to the table 40 in the axial direction).

In the clamping device 60, the piston 62 is accommodated in an accommodation groove that is formed in the body 11 of the frame 10, and is provided so as to be displaceable in the axial direction. More specifically, the body 11 of the frame 10 has the ring-shaped accommodation groove that is formed so as to open in the one-end-side end surface (the cover-12-side end surface) and that is concentrically formed with respect to the axis of the rotating shaft 20 accommodated in the accommodation hole 14 in the frame 10. The piston 62 is a ring-shaped member that is formed so as to substantially match the shape of the accommodation groove in the body 11. In addition, the piston 62 is inserted and fitted in the accommodation groove, and is displaceable in the axial direction. In the frame 10, an opening that communicates with the accommodation hole 14 exists between the cover 12 and an inner portion of the one-end-side end surface of the body 11 where the accommodation groove opens.

In addition, the clamp disc 61 is a disc-shaped member that is flexible. The clamp disc 61 is concentrically disposed with respect to the axis of the rotating shaft 20, and is secured to the rotating shaft 20 by using a screw member. However, the outside diameter of the clamp disc 61 is larger than the inside diameter of the accommodation hole 14. By disposing the clamp disc 61 in the axial direction thereof, the clamp disc 61 is positioned in the opening in the frame 10. An outer peripheral side portion of the clamp disc 61 has an outside diameter that allows it to overlap the piston 62 when viewed in the axial direction. Therefore, the outer-peripheral-side portion of the clamp disc 61 exists between the piston 62 and the cover 12 in the opening in the frame 10.

Moreover, in the clamping device 60, operating fluid (such as pressure oil) is supplied to the accommodation groove, and the pressure of the operating fluid displaces the piston 62 towards the cover 12, and the clamp disc 61 is brought into a state in which it is clamped by the piston 62 and the cover 12. By this, the clamp disc 61 is brought into an unrotatable state, as a result of which the rotating shaft is brought into an unrotatable state. Accordingly, in the rotary table device 1, during indexing processing, the rotating shaft 20 is indexed to an angular position that has been programmed by using the driving device 50, after which, by operating the clamping device, the rotating shaft 20 is brought into state in which it is held at the indexed angular position. In this state, a workpiece on the table 40 is processed.

In the present invention, the rotary table device 1 having the above-described structure includes an air seal mechanism that prevents entry of the aforementioned foreign materials into the frame 10 by ejecting compressed air from the inside of the frame 10. However, the present invention presupposes the use of the rotary table device 1 under the condition of use in which the rotating shaft is rotationally driven at a high peripheral speed of 10 m/s or greater; and provides the rotary table device 1 including such an air seal mechanism. The air seal mechanism is described in more detail below.

The air seal mechanism prevents entry of the aforementioned foreign materials into the frame by supplying compressed air to a space in the frame 10 (more specifically, a space between the outer peripheral surface of the rotating shaft 20 and the inner peripheral surface of the accommodation hole 14 in the frame 10) and ejecting the compressed air from a table-40-side end portion of the space (in the structure according to the embodiment, a portion between the outer peripheral surface of the rotating shaft 20 and an inner peripheral surface of the through hole in the cover 12). Therefore, the rotary table device 1 has a supply channel 70 that is formed so as to communicate with the space.

The space in the frame 10 exists over the range of existence of the rotating shaft 20 in the axial direction. Since the rotating shaft 20 is supported with respect to the frame 10 by the bearing 30, the space is substantially divided into a cover-12-side portion and a base-13-side portion by the bearing 30. Since the cover-12-side portion 80 of the space includes the portion between the outer peripheral surface of the rotating shaft 20 and the inner peripheral surface of the through hole in the cover 12, the supply channel 70 is formed in the body 11 of the frame 10 so as to communicate with the cover-12-side portion 80. Therefore, the cover-12-side portion 80 that is disposed closer to the cover 12 than the bearing 30 is in the space corresponds to a gap (in the frame) according to the present invention.

In this structure, compressed air supplied to the gap 80 passes through the gap 80, and is ejected from the portion in the gap between the outer peripheral surface of the rotating shaft 20 and the inner peripheral surface of the through hole in the cover 12. Therefore, the gap 80 functions as a channel through which compressed air passes in the air seal mechanism, and corresponds to an air channel in the present invention. Further, a portion of the air channel that is disposed between the outer peripheral surface of the rotating shaft 20 and the inner peripheral surface of the through hole in the cover 12 in the air channel 80 and that ejects the compressed air corresponds to an ejection portion 81 (positioned at a most downstream side in the air channel 80).

Regarding the air channel 80 including the ejection portion 81, the space that is defined by the outer peripheral surface of the rotating shaft 20 and the inner peripheral surface of the accommodation hole 14 in the frame 10 functions as the air channel 80. Therefore, the air channel 80 exists along a circumference in the frame 10 so as to surround the rotating shaft 20. Consequently, the ejection portion 81 opens along the circumference with respect to the space between the frame 10 and the table 40 in the axial direction. Incidentally, in this structure, the aforementioned peripheral speed corresponds to the rotational speed of the outer peripheral surface of a portion of the one-end-side portion of the rotating shaft 20 defining the ejection portion 81 that opens into the aforementioned space between the table 40 and the frame 10.

In the rotary table device including the air seal mechanism having the above-described structure, according to the present invention, the air seal mechanism further includes a storing portion 82 for making uniform the pressure of compressed air that is ejected from the ejection portion 81 (that is, for uniformly ejecting the compressed air over the entire circumference of the ejection portion 81) in the air channel 80. The storing portion 82 is described in more detail below.

First, in the rotary table device 1 according to the embodiment, the rotating shaft 20 includes a diameter enlargement portion 20 that is formed on the one-end-side portion (which corresponds to the table-40 side) of the rotating shaft 20 and whose outside diameter is enlarged. However, with the rotating shaft 20 disposed in the accommodation hole 14, in the axial direction, the diameter enlargement portion 21 is formed on the rotating shaft 20 at a position that is closer to the bearing 30 than the cover 12 is. In other words, as mentioned above, with the rotating shaft 20 disposed in the accommodation hole 14, the diameter enlargement portion 21 is in a state in which it is positioned within the range of existence of the body 11 of the frame 10 in the axial direction.

As mentioned above, the accommodation hole 14 in the frame 10 (that is, the through hole in the body 11) is a hole for disposing (accommodating) the rotating shaft 20 therein. Therefore, in at least the range of existence of the diameter enlargement portion 21 in the axial direction, the through hole in the body 11 has an inside diameter that is larger than the outside diameter of the diameter enlargement portion 21 of the rotating shaft 20. An outer peripheral surface of the diameter enlargement portion 21 of the rotating shaft 20 and the inner peripheral surface of the through hole in the body 11 facing the outer peripheral surface of the diameter enlargement portion 21 define a portion of the aforementioned gap 80.

In the rotary table device 1 according to the embodiment, in the axial direction, with a table-40-side end surface of an inner ring of the bearing 30 that supports the rotating shaft 20 being in contact with an end surface of the diameter enlargement portion 21 of the rotating shaft 20 opposite to the table 40, the inner ring of the bearing 30 is fitted to the rotating shaft 20. Moreover, with such a disposition in the axial direction, an outer ring of the bearing 30 is fitted to the inner peripheral surface of the through hole in the body 11.

Accordingly, a portion 11a of the body 11 to which the bearing 30 (outer ring) is fitted (hereunder may also be called a “bearing supporting portion” 11a) has an inside diameter that is substantially the same as the outside diameter of the diameter enlargement portion 21. By this, the bearing supporting portion 11a is positioned inwardly in a radial direction from the inner peripheral surface of the through hole in the body 11 facing the outer peripheral surface of the diameter enlargement portion 21, and, in the radial direction, exists over a range from the inner peripheral surface of the through hole to the outer peripheral surface of the diameter enlargement portion 21. In the radial direction, the bearing 30 is positioned within the range of existence of the diameter enlargement portion 21.

In the axial direction, a table-40-side end surface of the bearing supporting portion 11a is formed so as to be positioned substantially in correspondence with the table-40-side end surface of the bearing 30. Therefore, in the axial direction, the table-40-side end surface of the bearing supporting portion 11a is positioned in correspondence with the end surface of the diameter enlargement portion 21 opposite to the table 40. By this, in the radial direction, a portion of the gap 80 between the outer peripheral surface of the diameter enlargement portion 21 and the inner peripheral surface of the through hole in the body 11 is such that one end within a range thereof is defined by the table-40-side end surface of the bearing supporting portion 11a.

Moreover, a downstream-side end of the aforementioned supply path 70 is formed so as to open at the table-40-side end surface of the bearing supporting portion 11a. This causes the downstream-side end of the supply path 70 to communicate with a space (hereunder called a “first partial space”) 82 forming a portion of the gap 80. Therefore, in the gap 80, which is the cover-12-side portion of the space in the frame 10 that is disposed closer to the cover 12 than the bearing 30 is, the first partial space 82 is a space that is situated at the most upstream side of the gap 80. An upstream-side end of the supply path 70 opens at an outer peripheral surface of the body 11 of the frame 10.

Incidentally, the inside diameter of the through hole in the cover 12 is smaller than the outside diameter of the diameter enlargement portion 21 of the rotating shaft 20. Therefore, the cover 12 and the diameter enlargement portion 21 overlap each other in the radial direction. In other words, in the radial direction, the inner peripheral surface of the through hole in the cover 12 is positioned inwardly of the outer peripheral surface of the diameter enlargement portion 21. Therefore, in the axial direction, the first partial space 82 that is defined by the outer peripheral surface of the diameter enlargement portion 21 of the rotating shaft 20 and the inner peripheral surface of the through hole in the body 11 in the radial direction has a range that is defined by the table-40-side end surface of the bearing supporting portion 11a and the one end surface of the cover 12.

Although, as mentioned above, the cover 12 of the frame 10 and the diameter enlargement portion 21 of the rotating shaft 20 overlap each other in the radial direction, they are slightly separated from each other in the axial direction. That is, a portion of the cover 12 of the frame 10 and a portion of the diameter enlargement portion 21 of the rotating shaft 20 are disposed apart from each other and face each other in the axial direction. Therefore, at a location between the frame 10 and the rotating shaft 20, a space (hereunder called a “second partial space”) 83 that is defined by the one end surface of the cover 12 and a table-40-side end surface of the diameter enlargement portion 21 that face each other exists. The second partial space 83 forms a portion of the gap 80. In other words, a portion of the gap 80 is defined by the one end surface of the cover 12 and the table-40-side end surface of the diameter enlargement portion 21 that face each other in the axial direction.

The second partial space 83 is a space extending over the range of protrusion of the diameter enlargement portion 21 from a portion (front end portion) of the rotating shaft 20 that is disposed closer to the table 40 than the diameter enlargement portion 21 is. The second partial space 83 communicates with the aforementioned first partial space 82. However, an interval in the axial direction between the one end surface of the cover 12 and the table-40-side end surface of the diameter enlargement portion 21 that define the second partial space 83 is smaller than an interval in the radial direction between the outer peripheral surface of the diameter enlargement portion 21 and the inner peripheral surface of the through hole in the body 11 that define the first partial space 82.

As mentioned above, the through hole in the cover 12 of the frame 10 forms a portion of the accommodation hole 14, and the front end portion of the rotating shaft 20 is disposed in the through hole in the cover 12. Therefore, the through hole in the cover 12 obviously has an inside diameter that is larger than the outside diameter of the front end portion of the rotating shaft 20. Moreover, the inside diameter of the through hole in the cover 12 allows a slight opening to be formed between the inner peripheral surface of the through hole in the cover 12 and an outer peripheral surface of the front end portion of the rotating shaft 20 facing the inner peripheral surface of the through hole.

Therefore, around the front end portion of the rotating shaft 20, a space (hereunder called a “third partial space”) 81 that is defined by the outer peripheral surface of the front end portion and the inner peripheral surface of the through hole in the cover 12 exists. The third partial space 81 forms a portion of the gap 80. The third spatial space 81 communicates with the above-described second partial space 83, and communicates with the space between the table 40 and the frame 10. Therefore, the third partial space 81 is a space that forms a most downstream-side portion of the gap 80. That is, the most downstream-side portion of the gap 80 is defined by the outer peripheral surface of the front end portion of the rotating shaft 20 and the inner peripheral surface of the through hole in the cover 12. Incidentally, an interval in the radial direction between the outer peripheral surface of the front end portion of the rotating shaft 20 and the inner peripheral surface of the through hole in the cover 12 that define the third partial space 81 is smaller than the interval in the axial direction between the one end surface of the cover 12 and the table-40-side end surface of the diameter enlargement portion 21 that define the second partial space 83.

As described above, the gap 80 in the frame 10, which is the air channel of the air seal mechanism, includes the most upstream-side first partial space 82 defined as described above, the most downstream-side partial space 81 defined as described above, and the second partial space 83 which is an intermediate (midstream) partial space between the first partial space 82 and the third partial space 81, which connects the first partial space 82 and the third partial space 81 to each other, and which is defined as described above. The most downstream-side third partial space 81 corresponds to the aforementioned ejection portion of the air channel 80 of the air seal mechanism.

As described above, the gap 80, which functions as the air channel in the air seal mechanism, includes the first partial space 82, the second partial space 83, and the third partial space 81, which are formed by the internal structure of the rotary table device 1. However, when considered as the air channel 80, the air channel 80 is a channel in which an upstream-side partial channel (upstream partial channel) is formed by the first partial space 82, a midstream-portion partial channel (midstream partial channel) is formed by the second partial space 83, and a downstream-side partial channel (downstream partial channel) is formed by the third partial space 81. The size of each of the partial channels 81, 82, and 83 may be the width of a channel with respect to a direction of flow of compressed air in the air channel 80 (hereunder called a “channel width”). Further, the channel width corresponds to an interval between portions defining a particular partial channel in the width direction, the interval between the portions being an interval between a portion of the frame 10 and a portion of the frame 10 or an interval between a portion of the frame 10 and a portion of the rotating shaft 20.

However, in the direction of flow of compressed air referred to here, the air seal mechanism is provided for preventing the entry of the aforementioned foreign materials into the frame 10 as described above, and acts to achieve this purpose by allowing the compressed gas supplied from the supply channel 70 to flow towards the ejection portion 81 at the downstream side from the upstream side (which is the side of the supply channel 70) and to be ejected from the ejection portion 81. On the other hand, the air channel 80 exists along the circumference around the rotating shaft 20 as mentioned above. The supply of compressed gas to the air channel 80 is performed not along the entire circumference but only along a portion of the circumference. Therefore, as the compressed air is supplied from the supply channel 70, not only a flow of compressed air from the upstream side towards the ejection portion 81 such as that mentioned above is generated but also a flow of compressed air in a circumferential direction is generated in the air channel 80.

However, in the air seal mechanism, the flow of compressed air that is essentially required is a flow in the direction from the aforementioned upstream side (that is, the side of the supply channel 70) towards the ejection portion 81. The flow in the circumferential direction is merely a flow for causing the compressed air to spread to the same circumference in the air channel 80. Therefore, as the air channel 80 for the air sealing, the direction of flow of the compressed air for determining its amount is the direction of flow from the aforementioned upstream side towards the ejection portion 81. Regarding the air channel 80, the upstream side referred to here not only refers to a communicating portion of the supply channel 70 (a portion of the circumference). The upstream side refers to the communicating portion of the supply channel 70 and portions along substantially the same circumference in its entirety.

Moreover, the channel widths of the partial channels 81, 82, and 83 (which are the sizes of the partial channels 81, 82, and 83 in the air channel 80) each refer to an interval between portions defining the partial channel in the direction of the channel width with respect to the aforementioned direction of flow of compressed air in the air channel 80 (that is, the direction of flow from the upstream side towards the ejection portion 81), the interval between the portions being an interval between a portion of the frame 10 and a portion of the frame 10 or an interval between a portion of the frame 10 and a portion of the rotating shaft 20. Therefore, regarding the channel width of the upstream partial channel 82, the direction of flow towards the ejection portion 81 in the upstream partial channel 82 is the axial direction, and the direction of the channel width with respect to the direction of this flow is the radial direction. Therefore, the channel width corresponds to an interval in the radial direction between the inner peripheral surface of the through hole in the body 11 and the outer peripheral surface of the diameter enlargement portion 21 that define the first partial space 82.

Regarding the channel width of the midstream partial channel 83, the direction of flow towards the ejection portion 81 in the midstream partial channel 83 is the radial direction, and the direction of the channel width with respect to the direction of this flow is the axial direction. Therefore, the channel width corresponds to an interval in the axial direction between the one end surface of the cover 12 and the table-40-side end surface of the diameter enlargement portion 21 that define the second partial space 83. Further, regarding the channel width of the downstream partial channel (ejection portion) 81, the direction of flow of compressed air flowing through the downstream partial channel 81 is the axial direction, and the direction of the channel width with respect to the direction of this flow is the radial direction. Therefore, the channel width corresponds to an interval in the radial direction between the inner peripheral surface of the through hole in the cover 12 and the front end portion of the rotating shaft that define the ejection portion 81.

Moreover, as mentioned above, in the rotary table device 1, the interval in the radial direction between the inner peripheral surface of the through hole in the body 11 and the outer peripheral surface of the diameter enlargement portion 21 that define the first partial space 82 is larger than the interval in the axial direction between the one end surface of the cover 12 and the table-40-side end surface of the diameter enlargement portion 21 that define the second partial space 83. Therefore, the air channel 80 is formed such that the upstream partial channel 82 has a channel width that is larger than the channel width of the midstream partial channel 83 that is positioned downstream from the upstream partial channel 82. Therefore, in the air channel 80, the upstream partial channel 82 that is formed in the above-described manner corresponds to the storing portion in the present invention.

Incidentally, as mentioned above, the interval in the axial direction between the one end surface of the cover 12 and the table-40-side end surface of the diameter enlargement portion 21 that define the second partial space 83 is larger than the interval in the radial direction between the outer peripheral surface of the front end portion of the rotating shaft and the inner peripheral surface of the through hole in the cover 12 that define the third partial space 81, which is the ejection portion 81. Therefore, in the air channel 80, the channel width of the ejection portion (that is, the downstream partial channel) 81 that is positioned at the most downstream side is smaller than the channel width of the storing portion (upstream partial channel) 82.

In the rotary table device 1 according to the embodiment having the above-described structure, at least during processing of a workpiece, compressed air is supplied to the supply channel 70 from an air supplying device (not shown), and is supplied to the air channel 80 via the supply channel 70. This causes, in the air channel 80, the compressed air to flow in a direction of flow from the storing portion 82, which is the upstream partial channel that is positioned at the upstream side (the side of the supply channel 70), into the ejection portion 81, which is the downstream partial channel, via the midstream partial channel 83. Then, the compressed air that has flown into the ejection portion 81 is ejected from the space between the table 40 and the frame 10 via the ejection portion 81. As a result, at least during the processing of the workpiece, the compressed air from the inside of the frame 10 is brought into a state in which it is ejected towards the outside from the space between the table 40 and the frame 10, so that entry of the aforementioned foreign materials into the frame 10 via the space between the table 40 and the frame 10 is prevented.

Regarding the flow of compressed air towards the ejection portion 81 from the storing portion 82, more specifically, when compressed air of high pressure is supplied to the air channel 80 from the supply channel 70, in the storing portion 82, the air pressure in a portion of the storing portion 82 that communicates with the supply channel 70 is in a high state in accordance with the pressure of the compressed air that is supplied. This causes, in the storing portion 82, the circumferential-direction flow of the compressed air to be generated, as a result of which the air pressure is gradually increased in the entire storing portion 82 (that is, the entire circumference thereof). As the air pressure in the storing portion 82 increases, a flow of compressed air from the storing portion 82 is also generated in the midstream partial channel 83 that communicates with the storing portion 82 and that is connected to the space disposed between the table 40 and the frame 10 and outside the frame 10. By this, the compressed air that has passed through the midstream partial channel 83 flows into the ejection portion 81 and is brought into a state in which it is ejected towards the space between the table 40 and the frame 10.

Moreover, as mentioned above, the air channel 80 is formed such that the storing portion 82, which is the upstream partial channel that is positioned at the upstream side (that is, the side of the supply channel 70), has a channel width with regard to the direction of flow of the compressed air that is larger than that of the midstream partial channel 83 that communicates with the storing portion 82. In other words, the air channel 80 has a structure in which the channel width is smaller at a portion corresponding to the midstream partial channel 83. By this structure, a portion of the compressed air that is supplied from the supply channel 70 is gradually stored in the storing portion 82. The air pressure is brought into a state in which it is substantially uniform over the entire storing portion 82 (that is, the entire circumference thereof).

More specifically, in the air channel 80, as the compressed air is supplied from the supply channel 70, a flow of compressed air towards the midstream partial channel 83 (that is, towards the ejection portion 81) from the storing portion 82 is generated as described above. However, as mentioned above, in the air channel 80, the channel width of the midstream partial channel 83 is smaller than the channel width of the storing portion 82; and, compared to the resistance to the flow in the circumferential direction in the storing portion 82 whose channel width is large, the resistance to the flow of compressed air when the compressed air flows into the midstream partial channel 83 from the storing portion 82 is large.

Therefore, in the air channel 80, the flow of compressed air supplied to the storing portion 82 is primarily towards the circumferential direction than towards the ejection portion 81. That is, although a portion of the compressed air supplied to the storing portion 82 flows towards the ejection portion 81, the compressed air supplied to the storing portion 82 primarily flows into and is stored in the storing portion 82. Therefore, as the supply of compressed air from the supply channel 70 is continued, the compressed air is gradually stored in the storing portion 82, and, over the entire storing portion 82, the air pressure is increased to an air pressure that is about the same as the pressure of the compressed air that is being supplied. As a result, the air pressure in the storing portion 82 is brought into a state in which it is substantially uniform over the entire storing portion 82 at a pressure that corresponds with the pressure of the compressed air that is being supplied.

Since the air pressure is brought into a substantially uniform state over the entire storing portion 82 in this way, the pressure of the compressed air that flows towards the ejection portion 81 from the storing portion 82 is also brought into a substantially uniform state over the entire (that is, the entire circumference of) the midstream partial channel 83 and the ejection portion 81 at a pressure corresponding to the pressure of the compressed air that is being supplied. Therefore, by setting the pressure of the compressed air that is supplied to the air channel 80 from the supply channel 70 to a suitable pressure, the compressed air of a desired pressure is brought into a state in which it is ejected towards the space between the table 40 and the frame 10 over the entire circumference around the rotating shaft 20. This causes a sealed state provided by the air seal mechanism to be closer to a perfect state, that is, the sealing effect by the air seal mechanism to be increased further.

Although the rotary table device according to an embodiment of the present invention is described, the present invention is not limited to the embodiment, and thus can be realized by the following modifications.

Regarding the air channel of the air seal mechanism, the air channel 80 according to the embodiment includes, in addition to the storing portion 82 (which is the most upstream side partial channel) and the ejection portion 81 (which is the most downstream side partial channel), the midstream partial channel 83 that connects the storing portion 82 and the ejection portion 81 to each other. More specifically, in the embodiment, the rotary table device 1 has a structure in which the clamping device 60 is provided closer to the table 40 than the bearing 30 is, and the rotating shaft 20 includes the diameter enlargement portion 21 (provided for mounting the clamp disc 61 of the clamping device 60 thereon) in the gap 80, as a result which the air channel 80 includes the midstream partial channel 83 as mentioned above.

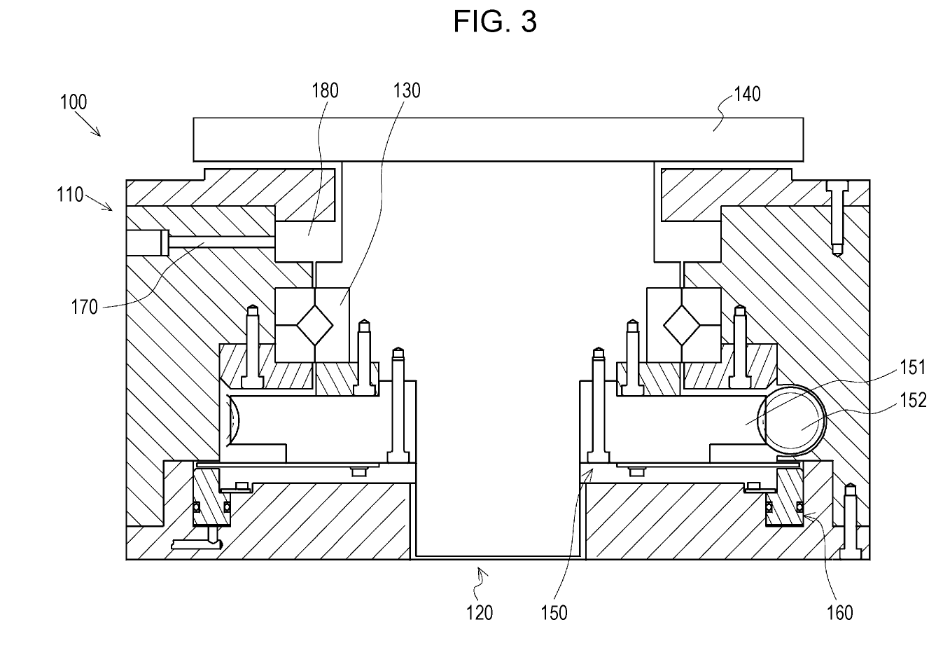

However, the present invention is not limited to the rotary table device including the clamping device that is disposed as in the embodiment. For example, as shown in FIG. 3, the present invention is applicable to a rotary table device 100 including a clamping device 160 that is disposed at a side opposite to a table 140 with a bearing 130 interposed therebetween. Here, when the clamping device is disposed in this manner, it is possible to omit the diameter enlargement portion 21 of the rotating shaft 20 that is positioned in the gap 80 in the structure of the rotary table device 1 according the embodiment. When the rotating shaft 20 does not include the diameter enlargement portion 21 in the structure according to the embodiment, the air channel has a structure in which the midstream partial channel 83 in the embodiment is omitted, that is, the ejection portion directly communicates with the downstream side of the storing portion.

Accordingly, the air channel of the air seal mechanism according to the present invention only needs to include at least an ejection portion and a storing portion, that is, may include only an ejection portion and a storing portion. Further, the structure of the air channel is not limited to one in which the storing portion is positioned at the most upstream side of the air channel as in the embodiment. The structure of the air channel may be one in which a channel is provided upstream from the storing portion.

Regarding the supply channel, the air seal mechanism according to the embodiment has a structure in which the supply channel 70 communicates with only one location in the air channel 80. However, in the present invention, the air seal mechanism is not limited to one having a supply channel formed in this way. The air seal mechanism may have a structure in which the supply channel communicates with a plurality of locations in the air channel.

In such a structure, for example, a single supply channel formed in the frame as in the embodiment may be branched into two or more portions at a portion of the supply channel that is located upstream from a communication position where the supply channel communicates with the air channel, and each branch channel formed after the branching may be made to communicate with the air channel. In the present invention, since the number of supply channels of the air seal mechanism is not particularly limited to a certain number of supply channels, the air seal mechanism may include a plurality of independent supply channels. More specifically, the air seal mechanism may have a structure in which two or more supply channels (one of which is described in the embodiment or is illustrated in FIG. 3) that are disposed at different locations in the circumferential direction. Even in this case, the air seal mechanism has a structure in which the supply channels communicate with a plurality of locations in the air channel. In the case of this structure, each supply channel may be connected to a single air supplying device, or each supply channel may be connected to its corresponding different air supplying device.

Regarding the rotary table device that the present invention presupposes, in the embodiment, the driving device of the rotary table device corresponds to the driving device 50 that principally includes the DD motor 51 that directly rotationally drives the rotating shaft 20. However, the driving device of the rotary table device that the present invention presupposes is not limit to one having such a structure. The driving device may be one using a worm gear mechanism such as that shown in FIG. 3. Incidentally, the driving device 150 of the rotary table device 100 shown in FIG. 3 includes a drive transmission mechanism and a driving motor (not shown). The drive transmission mechanism includes a worm wheel 151 that is mounted on the rotating shaft 120 so as to be unrotatable with respect to the rotating shaft 120, and a worm spindle 152 that engages with the worm wheel 151 so as to be rotatably supported with respect to a frame 110. The driving motor rotationally drives the worm spindle 152.

Regarding the clamping device, in the embodiment, the so-called disc-type clamping device 60 that holds the rotating shaft 20 in an unrotatable state by press-contacting the piston 62 against the clamp disc 61 secured to the rotating shaft 20 is used. However, the clamping device of the rotary table device that the present invention presupposes is not limited to such a disc type. Other publicly known clamping devices may be used. Incidentally, examples of such publicly known clamping devices include a so-called sleeve-type clamping device and a so-called coupling-type clamping device. The sleeve-type clamping device holds the rotating shaft by friction force generated at a contact surface between a clamp sleeve (provided around the rotating shaft) and the rotating shaft by bringing the clamp sleeve into contact with the rotating shaft as a result of flexing the clamp sleeve in a diameter reduction direction. The coupling-type clamping device holds the rotating shaft by moving one of the coupling members that are provided so as to oppose each other at the frame and the rotating shaft towards the other coupling member by, for example, the pressure of working fluid and by engaging the teeth on opposing surfaces of the coupling members with each other.

Further, the present invention is not limited to any of the above-described modifications, and, thus, various changes can be made without departing from the gist of the present invention.

What is claimed is:

1. A rotary table device for a machine tool, comprising:
a rotating shaft to whose one end a disc-shaped table for mounting a workpiece thereon is secured;
a frame that has an accommodation hole for accommodating the rotating shaft, and that rotatably supports the rotating shaft by a bearing in the accommodation hole;
a driving device that rotationally drives the rotating shaft;
a clamping device that holds the rotating shaft at an indexed angular position during indexing processing,
wherein the rotating shaft is rotationally driven at a peripheral speed of 10 m/s or greater by the driving device; and
an air seal mechanism which has a supply channel formed in the frame so as to communicate with a gap which is formed in the frame, which is defined by an inner peripheral surface of the accommodation hole in the frame and an outer peripheral surface of the rotating shaft, and which is positioned closer to the table than the bearing is, the air seal mechanism preventing entry of foreign material into the frame by supplying compressed air to an air channel and ejecting the compressed air from an inside of the frame, with the gap functioning as the air channel when the compressed air is supplied via the supply channel,
wherein the air channel includes a storing portion that is disposed upstream from an ejection portion, the ejection portion being a most downstream side portion of the air channel, and
wherein a channel width of the storing portion is larger than a channel width of a portion of the air channel that is disposed downstream from the storing portion.
